(19) United States
(12) Patent Application Publication
(10) Pub. No.: US 2008/0056367 A1
(43) Pub. Date: Mar. 6, 2008

(54) Multi-step directional-line motion estimation

(76) Inventor: Liu Wenjin, Cupertino, CA (US)

Correspondence Address: INNOVATION MANAGEMENT SCIENCES, P. O. BOX 1169, LOS ALTOS, CA, 94023-1169, US

(21) Appl. No.: 11/513,818

(22) Filed: Aug. 30, 2006

(51) Int. Cl. H04N 11/02; H04B 1/66

(52) U.S. Cl. 375/240.16; 375/240.27

(57) ABSTRACT

A method, system and computer program product for motion estimation of video data is disclosed. A lower density search utilizing a Directional-line Motion Estimation (DME) pattern is performed to identify a general vicinity of a best match. Thereafter, a higher density localized search is performed to refine the position of the best match. A sub-pixel search may be used to further refining the position of the best match. The present invention provides an excellent mix of high computational efficiency and motion estimation accuracy, and is particularly adaptable for use in mobile telephones, surveillance cameras, handheld video encoders, or the like.

### FIELD OF THE INVENTION

The invention relates generally to video encoding. More specifically, the invention relates to a method, system and computer program product for encoding video data in which a motion estimation step comprises a directional-line motion estimation and a localized full search.

### BACKGROUND OF THE INVENTION

In video encoding, Motion Estimation (ME) is an important step as it has a direct effect on image quality. Video post-processing, such as motion-compensated filtering and deinterlacing, requires a reliable ME. Further, the ME is also a computationally intensive process, possibly one of the most computationally intensive steps of video encoding.

One of the most widely used algorithms for ME is Full Search motion estimation. In Full Search algorithm rectangular windows, for example an N×N blocks, are matched against a search region of a reference frame (or field). The matching criterion is typically based on the sum of absolute errors (SAE), defined as

$$SAE = {\sum }_{i = 0}^{N - 1} {\sum }_{j = 0}^{N - 1} \vert {C}_{ij} - {R}_{ij} \vert ,$$

where Cᵢⱼ and Rᵢⱼ are current and reference area samples, respectively. In Full Search, the SAE for every possible offset position between the block and the search region of the reference frame is evaluated. The offset position with the minimum SAE is selected as the best choice for a motion vector. For example, consider matching an 8×8 block to a 16×16 search region of the reference frame. Full Search involves evaluating the SAE at each and every pixel position in the search region, and selecting the pixel position with the minimum SAE as the motion vector. The search location where the minimum SAE is found is also called “best match.” This algorithm provides a high quality predicted image, but it is computationally intensive as a very large number of comparisons are made.

In applications where less computationally intensive motion estimation algorithms are required, Full Search motion estimation is not suitable. For such applications, “fast search” algorithms are preferable. These algorithms operate by calculating the match error (e.g., SAE) for a fewer number of locations within the search region, and select the location with the match error as the “best match.”

One such “fast search” algorithm, known as Nearest Neighbor Search (NNS), calculates the SAE at position (0, 0) (the center of the search region) and at eight locations surrounding the position (0, 0). The search location that yields the minimum SAE is selected as the new search center. Thereafter, a further eight locations surrounding the new search center are searched. Once again the search location yielding the minimum SAE is selected as the new search center. These same steps can be repeated for a number of times, and the search location with the minimum SAE overall is selected as the “best match.” This NNS method is computationally less intensive than the Full Search method, but the compression ratio is often less than optimal because the search may be trapped within a local minimum and further, many search locations are ignored.

Another “fast search” algorithm is known as the Diamond Search. In this method the search region is shaped like a diamond. The match error at every possible offset position between the block and the diamond-shaped search region is computed, but the “corners” of the reference frame outside the search region are ignored. The search location that yields the minimum SAE is selected as the “best match.” The Diamond Search method is computationally less intensive than the Full Search method, but the compression ratio is often not optimal because possible search locations are often located within the corners of the search window, which are ignored.

In light of the above discussion, there is a need for a method and system that performs motion estimation efficiently. The method and system should also estimate a motion vector accurately.

### SUMMARY

An object of the invention is to perform motion estimation with a high accuracy and high computational efficiency.

To achieve the above and other objectives, the present invention provides a novel method, system and computer program product for motion estimation for video data. The method includes dividing a current frame into one or more macroblocks. The method further includes the step of receiving or determining a first search center within an area of the reference frame as the initial point for motion estimation. Subsequently, a Directional-line Motion Estimation (DME) pattern including selected search locations on or near directional lines originating from or passing through near the first search center is defined. Thereafter, match errors at some or all of the selected search locations within the DME pattern are computed, resulting in a first set of match errors. The search location with the least match error is selected as the second search center. Thereafter, an area surrounding the second search center is selected as the Localized Full Search (LFS) window. Match errors at some or all of the search locations within the LFS window are computed to generate a second set of match errors. The search location with the least match error overall (e.g., among the first and second sets) is selected as a best match. Further, the method may include a step for performing a sub-pixel search for further refining the position of the best match. A motion vector may be produced based on the pixel position of the best match.

In another embodiment of the invention, the computer program product for motion estimation includes a program instruction means for estimating a first search center within an area of the reference frame. The first search center is the initial point for motion estimation. Further, the computer program product for motion estimation includes a program instruction means for defining a DME pattern including selected search locations on or near directional lines originating from or passing through near the first search center. The computer program product includes program instruction means for computing match errors at some or all of the selected search locations within the DME pattern to generate a first set of match errors. The search location with the minimum match error among the first set of match errors is selected as a second search center. The computer program product further includes a program instruction means for selecting an area surrounding the second search center as the LFS window, and a program instruction means for computing match errors at some or all of the search locations within the LFS window to generate a second set of match errors. Thereafter, the search location with the minimum match error overall (e.g., among the first and second sets) is selected as a best match. Further, the computer program product may include a program instruction means for performing a sub-pixel search further refining the position of the best match. The computer program product may further include a program instruction means for producing a motion vector based on the pixel position of the best match.

In yet another embodiment of the invention, the system for motion estimation includes a Directional Motion Estimation (DME) module and a Localized Full Search (LFS) module. The DME module estimates a first search center within an area of the reference frame. Thereafter, the DME module defines a DME pattern including selected search locations on or near directional lines originating from or passing through near the first search center. The DME module further computes match errors some or all of the search locations within the DME pattern, and selects the search location having the minimum match error as the second search center. The LFS module selects an area surrounding the second search center as the LFS window. Then the LFS module computes match at some or all of the search locations within LFS window to generate a second set of match errors. Subsequently, the LFS module selects the search location having the least match error overall (e.g., among the first and second sets) as a best match. Further, the system may include a module for performing a sub-pixel search for further refining the position of the best match. The system may further include a module for providing a motion vector based on the pixel position of the best match.

When compared with existing motion estimation algorithms, the algorithm of the present invention provides significantly higher efficiency without losing motion estimation accuracy. Further, the algorithm of the present invention is computationally less intensive while providing a high video quality.

### BRIEF DESCRIPTION OF THE DRAWINGS

The invention will now be described with reference to the accompanying drawings which are provided to illustrate various example embodiments of the invention. Throughout the description, similar reference names may be used to identify similar elements.

FIG. 1 depicts an exemplary frame of video data in accordance with an embodiment of the invention.

FIG. 2 depicts a current frame and a reference frame in accordance with an embodiment of the invention.

FIG. 3 depicts a Directional-line Motion Estimation (DME) pattern in search area in accordance with an embodiment of the invention.

FIG. 4 depicts a second search center in search area in accordance with an embodiment of the invention.

FIG. 5 depicts a Localized Full Search method in accordance with an embodiment of the invention.

FIG. 6 depicts a sub-pixel motion search in search area in accordance with an embodiment of the invention.

FIG. 7 is a flowchart illustrating a method for motion estimation in accordance with an embodiment of the invention.

FIG. 8 is a flowchart illustrating a method for defining a DME search pattern in accordance with an embodiment of the invention.

FIG. 9 is a block diagram illustrating a system for motion estimation in accordance with an embodiment of the invention.

### DESCRIPTION OF VARIOUS EMBODIMENTS

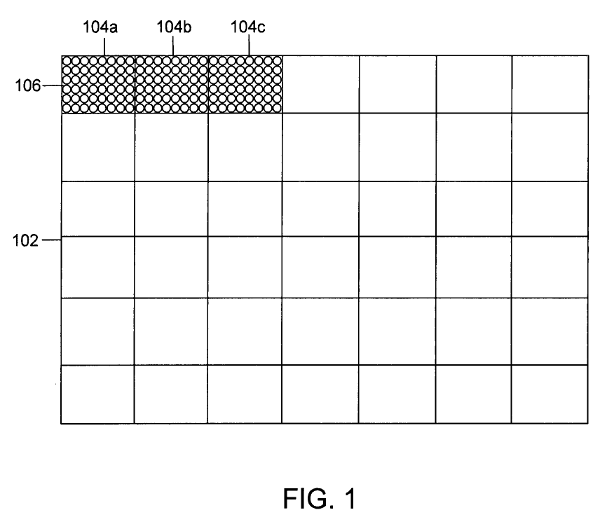

FIG. 1 depicts an exemplary frame 102 of video data in accordance with an embodiment of the invention. Frame 102 is divided into a plurality of macroblocks, such as macroblocks 104, including for example macroblocks 104a, 104b and 104c. A macroblock is defined as a region of a frame coded as a unit, usually composed of 16×16 pixels. However, many different block sizes and shapes are possible under various video coding protocols. Each of the plurality of macroblocks 104 includes a plurality of pixels. For example, macroblock 104a includes pixels 106. Each of the plurality of macroblocks 104 and pixels 106 includes information such as color values, chrominance and luminance values and the like. Macroblock 104 is hereinafter referred to as a “block 104”.

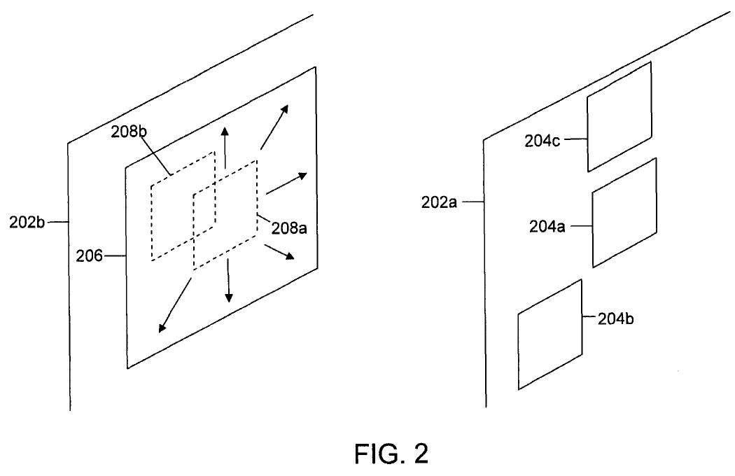

FIG. 2 depicts a current frame such as current frame 202a and a reference frame such as reference frame 202b in accordance with an embodiment of the invention. Current frame 202a includes a plurality of blocks including for example a block 204a, a block 204b and a block 204c.

Reference frame 202b includes a search area 206 that is centered on the same position as that of block 204a in current frame 202a. Search area 206 includes a plurality of selected regions 208 including for example selected regions 208a and 208b. In an embodiment of the invention, reference frame 202b is a previously encoded frame and may occur before or after current frame 202a in display order. According to an embodiment of the invention, the match errors between a block (e.g., block 204a) and various selected regions 208 (e.g., 208a, 208b) are computed. In various embodiments of the invention, the match error is based on the Sum of Absolute Errors (SAE), defined as

$$SAE = {\sum }_{i = 0}^{N - 1} {\sum }_{j = 0}^{N - 1} \vert {C}_{ij} - {R}_{ij} \vert ,$$

where Cᵢⱼ is the current frame and Rᵢⱼ is the reference frames respectively. The selected region with the minimum match error, such as for example selected region 208b, is selected as the best match for performing motion estimation. In one embodiment of the invention, the regions 208a, 208b may be chosen according to a Directional-line Motion Estimation (DME) pattern and/or a localized full search.

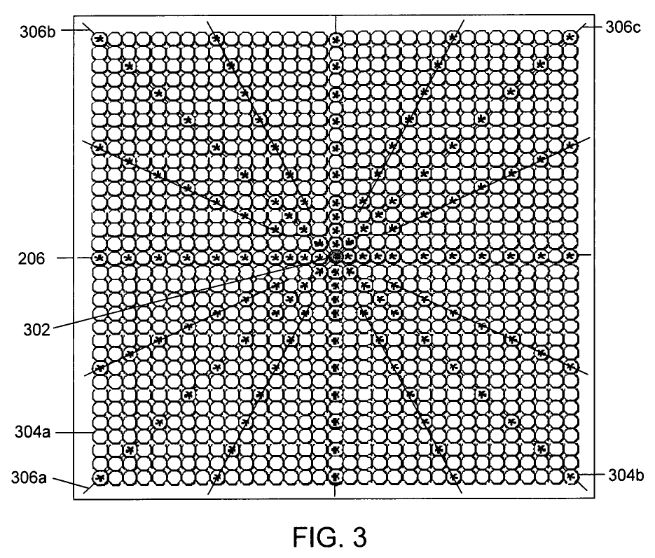

FIG. 3 depicts a Directional-line Motion Estimation (DME) pattern in search area 206 in accordance with an embodiment of the invention. Search area 206 includes a first search center 302, a plurality of pixels, such as pixels 304, including for example a plurality of pixels 304a and a group of pixels 304b, and a plurality of directional lines, such as for example directional lines 306a, 306b and 306c passing through first search center 302 (colored in gray).

Each of the plurality of directional lines 306 is separated from each other by approximately the same angle degree. The angle degree is empirically determined depending on the size of block 104. The size of block 104 is subject to motion estimation and the size of search area 206. In an embodiment of the invention, the angle degree between any two consecutive directional lines 306 is approximately 22.5°. Accordingly, the 22.5° angle degree results in sixteen directional lines. In another embodiment of the invention, directional lines 306 may originate from more than one pixel located at or near the center of search area 206.

The plurality of pixels 304a (uncolored), which lie between directional lines 306, are referred to as non-DME locations. The group of pixels 304b (which include an asterix) lying along directional lines 306 constitute a DME pattern in accordance with an embodiment of the invention, and may be used for computing a first set of match errors. Group of pixels 304b are hereinafter referred to as “search locations 304b.”

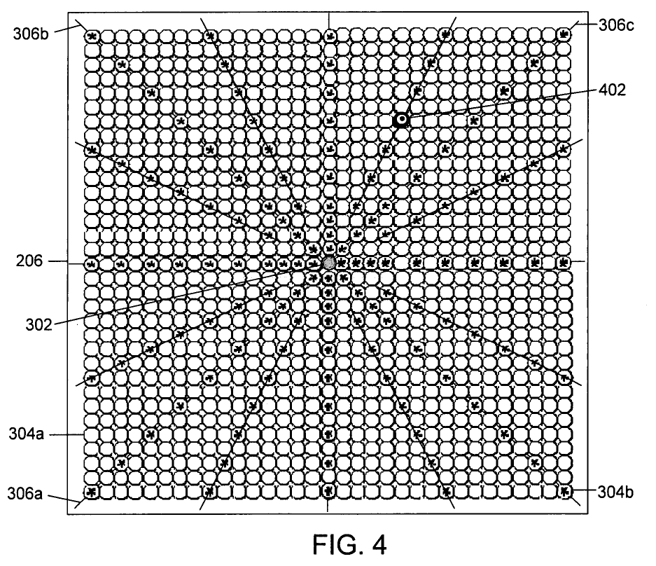

In an embodiment of the invention, a first set of match errors are calculated at the search locations 304b (and first search center 302). Match errors may be calculated using various different methods. In one embodiment of the invention, a match error may be calculated by determining a SAE between a current block, such as block 204a (shown in FIG. 2) and a block of pixels in reference frame 202b defined by (e.g., encompassing) a search location 304b. The search location with the minimum first match error among the first set of match errors is selected as second search center. An exemplary second search center 402 is depicted in FIG. 4 as a circle with thick boundaries and a dot in the center.

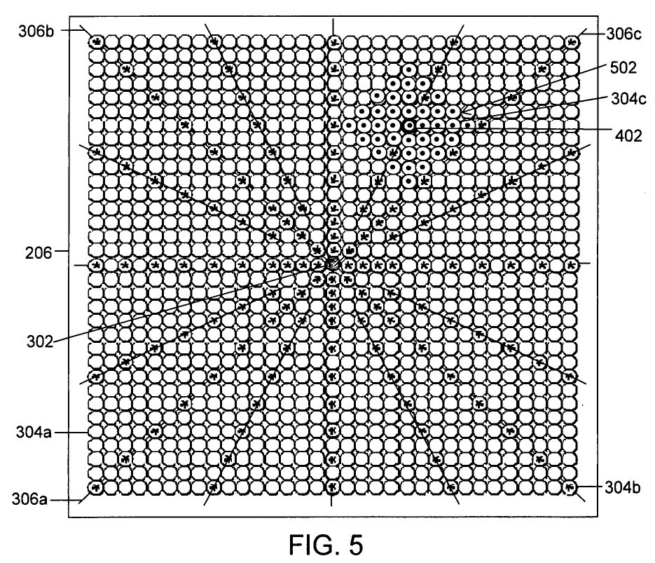

FIG. 5 depicts a Localized Full Search (LFS) method in accordance with an embodiment of the invention. FIG. 5 depicts search area 206, first search center 302, plurality of pixels 304, search locations 304b and a set of neighboring pixel positions around second search center 402, such as for example, a plurality of LFS positions 304c. A portion of the search area 206 around the second search center 402 is referred to herein as Localized Full Search (LFS) window 502.

In various embodiments of the invention, LFS window 502 is limited to a portion of search area 206. LFS positions 304c are depicted as circles with a dot. In various embodiments of the invention, LFS window 502 may be diamond-shaped, round-shaped, cross-diamond shaped and the like.

In an embodiment of the invention, a second set of match errors are calculated for each of the plurality of LFS positions 304c in LFS window 502. In one embodiment of the invention, a match error may be calculated by determining a SAE between the current block and a block of pixels in reference frame 202b defined by (e.g., encompassing) a LFS position 304c. The second set of match errors are compared against each other and against the match error at the second search center 402. The pixel location within LFS window 502 having the minimum match error overall is selected as a best match.

In an embodiment of the invention, the search range for LFS may be calculated adaptively according to the location of second search center 402. For example, if second search center 402 is located less than or equal to four pixels from first search center 302, the LFS range is one pixel, resulting in diamond-shaped LFS window with a three-pixel diagonal. If the position of second search center 402 is located more than four pixels but less than or equal to eight pixels from first search center 302, the LFS range is two pixels, resulting in a diamond-shaped LFS window with a five-pixel diagonal. If the position of second search center 402 is located more than eight pixels but less than or equal to twelve pixels from first search center 302, the LFS range is three pixels. If the position of second search center 402 is located more than twelve pixels but less than or equal to sixteen pixels, as depicted in FIG. 4 and FIG. 5, from first search center 302, the LFS range is four pixels, resulting in a diamond-shaped search window with a nine-pixel diagonal.

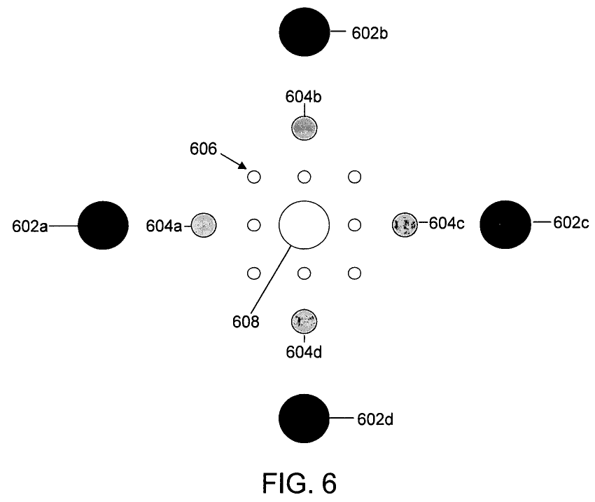

FIG. 6 depicts a fast sub-pixel motion search in search area 206 in accordance with an embodiment of the invention. Search area 206 includes a plurality of full pixel positions such as for example full pixel positions 602, including a full pixel positions 602a, 602b, 602c and 602d, half-pixel positions such as half pixel positions 604, including half-pixel positions 604a, 604b, 604c and 604d, a quarter-pixel position such as for example quarter pixel position 606 and a best full-pixel position 608.

In various embodiments of the invention, the fast sub-pixel search is performed to further refine the estimation of a motion vector. The fast sub-pixel motion search process is used to refine the block by generated interpolation. In an embodiment of the invention, a fast sub-pixel search is performed after the Localized Full Search is performed. The fast sub-pixel search is performed to further refine the position of the third search center by considering the information of the half-pixel and quarter-pixel positions. All positions on both half-pixel positions 604a and 604b and quarter-pixel positions 606a and 606c interpolated blocks are centered by full-pixel position 602a and 602b and have the shortest distances. The fast sub-pixel algorithm reduces the memory access and yields high accuracy motion search results.

It should be noted that embodiments of the present invention may be practiced without the fast sub-pixel search algorithm. Various methods of sub-pixel search, which may be apparent to those of ordinary skill in the art having benefit of the present disclosure, may be used to refine the position of the second search center.

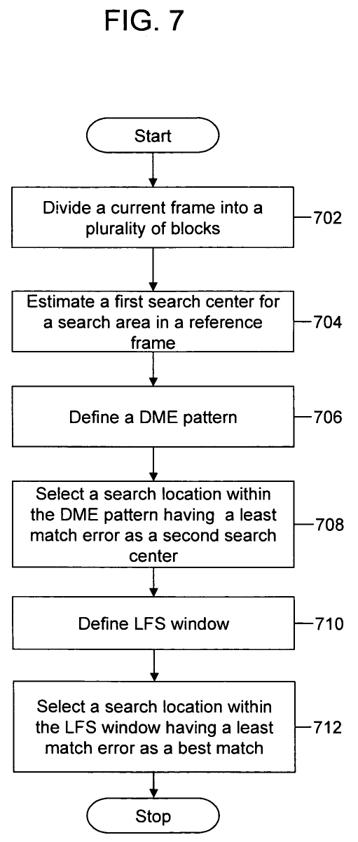

FIG. 7 is a flowchart illustrating a method for motion estimation in accordance with an embodiment of the invention. At 702, a current frame, such as current frame 202a, is divided into a plurality of blocks. Each of the plurality of blocks includes a plurality of pixels. At 704, a search center, such as first search center 302, is roughly estimated for one of the plurality of blocks in a reference frame, such as reference frame 202b. Various methods for roughly estimating the search center should be apparent to those of ordinary skill in the art having the benefit of the present disclosure.

At 706, a Directional-line Motion Estimation (DME) pattern for a search region in the reference frame is defined. In an embodiment of the invention, the DME pattern includes selected search locations, such as search locations 304b, along or near a plurality of directional lines, such as directional lines 306, originating from or near the search center.

At 708, the current block, a first set of match errors at some or all of the selected search locations are computed. As discussed above, a match error may be computed by calculating the SAE between a block of pixels such as for example block 204a (shown in FIG. 2) and a block of pixels in a reference frame, such as reference frame 202b, defined by (e.g., encompassing) a search location. In an embodiment of the invention, one match error is generated for first search center 302, and one match error is generated for each of search locations 304b. The pixel position with the minimum match error among the first set of match errors is selected as second search center (e.g., second search center 402).

In an embodiment of the invention, the comparison criterion is based on the Sum of All Errors (SAE). In various embodiments of the invention, other comparison criteria may be used. Furthermore, in various embodiments of the invention, a match error may not be computed for each and every one of the search locations within the DME pattern. For example, the comparison may stop if the match error becomes smaller than a predetermined threshold.

At 710, a Localized Full Search (LFS) window, such as LFS window 502, is defined. In an embodiment of the invention, the LFS window is defined by as a portion of the search area encompassing the location of the second search center. In one embodiment of the invention, the size of the LFS window may be fixed. In various embodiments of the invention, the search range for LFS window is calculated adaptively according to the location of the second search center relative to the first search center. For example, if the estimated second search center is located less than or equal to four pixels from the first search center, the localized full search range may be one pixel. If the estimated second search center is located more than four pixels but less than or equal to eight pixels from the first search center, the localized full search range may be two pixels, and so on.

At 712, a second set of match errors are computed at some or all of the search locations in the LFS window, such as plurality of LFS positions 304c. A search location with the minimum second match error among all the search locations is selected as the best match. In an embodiment of the invention, a fast sub-pixel search may be carried out using the best match to further refine its location. A motion vector for the current block may be produced from the best match search location.

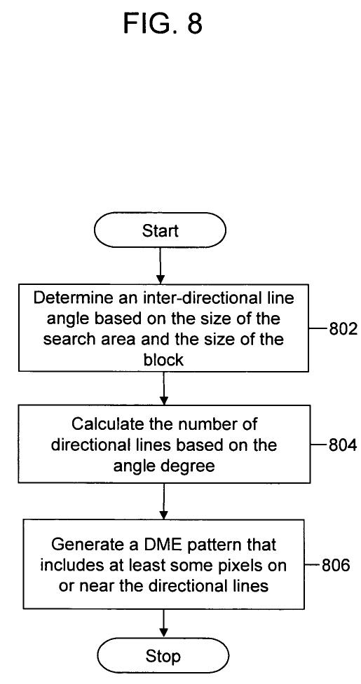

FIG. 8 is a flowchart illustrating a method for defining a DME search pattern in accordance with an embodiment of the invention. At 802, an inter-directional line angle is determined based on the size of the search area and the size of the block. In an embodiment of the invention, for a 16×16 block and a 33×33 pixels search area, the angle between two neighboring directional lines is approximately 22.5°. At 804, based on the angle degree a plurality of directional lines, such as directional lines 306 are determined.

It may be apparent to a person skilled in the art that if the angle degree is smaller the number of directional lines is higher. Accordingly, if the angle degree is higher the number of directional lines is lower. In various embodiments of the invention the angle degree may be changed based on the degree of compression required. In an embodiment of the invention, if a high degree of compression is required then the angle degree may be smaller. Similarly, if a low degree of compression is required then the angle degree may be higher.

At 806, pixels located on or near the directional lines are selected as part of the DME pattern. The pixels not located on or near the directional lines, such as pixels 304a are not considered as part of the DME pattern. Furthermore, some pixels located on or near the directional lines may not be part of the DME pattern. In an embodiment of the invention, not all pixels on the directional lines are part of the DME pattern. For example, in the DME pattern illustrated in FIG. 3, only the alternate pixels lying on directional lines 306 beyond four pixels from first search center 302 are part of the DME pattern.

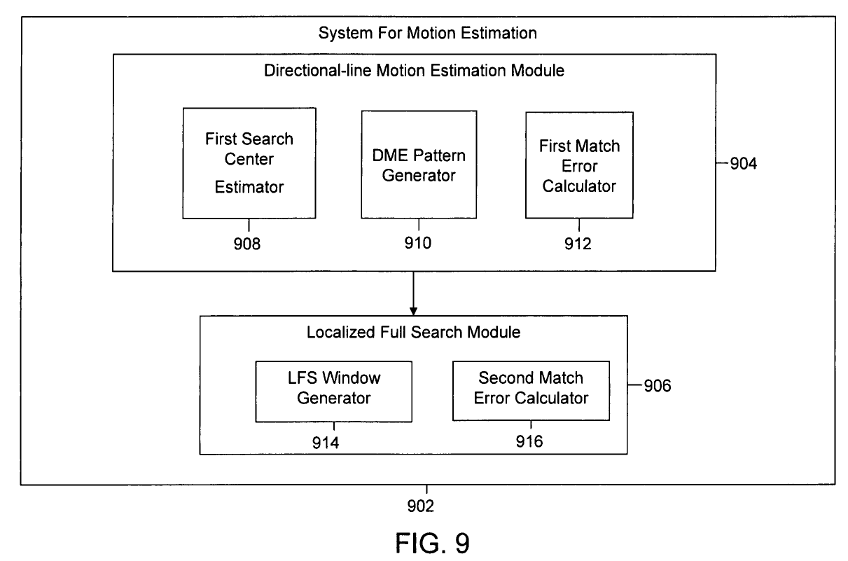

FIG. 9 is a block diagram illustrating a system for motion estimation 902 in accordance with an embodiment of the invention. System for motion estimation 902, which may be part of a video encoding subsystem of an electronic device (e.g., mobile telephone), includes a Directional-line Motion Estimation (DME) module 904 and a localized full search module 906. DME module 904 includes a first search center estimator 908, a DME pattern generator 910 and a first match error calculator 912. Localized Full Search (LFS) module 906 includes a LFS window generator 914 and a second match error calculator 916. In an embodiment of the invention, LFS module 906 may not include second match error calculator 916. Therefore, LFS module 906 uses first match error calculator 912 of DME module 904 to calculate the match errors.

In an embodiment of the invention, first search center estimator 908 generates first search center 302 for search area 206. DME pattern generator 910 generates a DME pattern, and first match error calculator 912 calculates the match errors at some or all of the search locations 304b within the DME pattern.

DME pattern generator 910 may include an angle degree calculator that calculates the inter-directional line angle, and a sub-module that generates the directional lines and identifies the pixels that lie on or near the directional lines. A second search center such as second search center 402 with the least match error among search locations 304b is selected by DME module 904 and is provided to LFS Module 906.

LFS window generator 914 generates an LFS window such as LFS window 502 using second search center 402. Subsequently, second match error calculator 916 calculates the match errors at some or all of the search locations within LFS window 502, such as the plurality of LFS positions 304c. The search location with the minimum match error overall is selected as a best match. In various embodiments of the invention, the best match may be provided to a fast sub-pixel search module to further refine the best match location. Other components of the system include a module for providing a motion vector for the current block based on the best match location.

The invention provides a method, system and computer program product for motion estimation. The method, system and computer program product combine the steps of performing a low intensity search, such as DME, to identify a general vicinity of a best match. Thereafter, a high intensity search, such as LFS, is performed to refine the position of the best match. A sub-pixel search may be used to further refining the position of the best match. Therefore, the method and system provides an excellent mix of high computational efficiency and motion estimation accuracy.

The method of the invention may be embodied by electronic device(s) that perform video encoding, such as mobile telephones, surveillance cameras, handheld video recorders or personal digital assistant (PDA) devices. The computer program product of the invention is executable on a computer system for causing the computer system to perform a method of video encoding including a motion estimation method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. Computer program mechanisms may include instructions executable by digital signal processors embedded within various video encoding systems.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. §112, paragraph 6.

What is claimed is:

1. A method for encoding video data comprising a current frame and a reference frame, the method comprising:
a. defining a plurality of directional lines on the search area, the directional lines originating from approximately a center of the search area;
b. computing a first set of match errors at a first group of pixels lying on or near the plurality of directional lines;
c. computing a second set of match errors at a second group of pixels in the vicinity of a selected pixel of the first group; and
d. generating a motion vector based on at least in part the first and second sets of match errors.

2. The method in accordance to claim 1, further comprising selecting a best match pixel having a least match error among the first and second sets for sub-pixel search.

3. The method in accordance to claim 2, further comprising performing a sub-pixel search using the best match pixel.

4. The method in accordance to claim 1, wherein the step (c) comprises computing match errors at substantially all pixels within a portion of the search area encompassing the selected pixel of the first group.

5. The method in accordance to claim 1, wherein the step (b) comprises computing a first match error by comparing a block of pixels in the current frame with a block of pixels in the reference frame that comprises one or more of the pixels of the first group.

6. The method in accordance to claim 5, wherein the step (c) comprises computing a second match error by comparing a block of pixels in the current frame with a block of pixels in the reference frame that comprises one or more of the pixels of the second group.

7. The method in accordance to claim 1, wherein the selected pixel of the first group has a least match error among the first set of match errors.

8. The method in accordance to claim 1, wherein the step (a) comprises determining an angle degree separating each of the plurality of directional lines based on at least in part a size of the search area.

9. The method in accordance to claim 1, wherein a size of the second group of pixels varies according to a distance of the selected pixel of the first group in relation to the center of the search area.

10. A system for encoding video data comprising a current frame and a reference frame, the system comprising:
a. a search pattern generation module for defining a plurality of directional lines on the search area, the directional lines originating from approximately a center of the search area;
b. match error calculation module for computing a first set of match errors at a first group of pixels lying on or near the plurality of directional lines and for computing a second set of match errors at a second group of pixels in the vicinity of a selected pixel of the first group; and
c. motion vector generation module for generating a motion vector based on at least in part the first and second sets of match errors.

11. The system in accordance to claim 10, wherein the match error calculation module selects a best match pixel having a least match error among the first and second sets as for sub-pixel search.

12. The system in accordance to claim 11, further comprising a sub-pixel search module that performs a sub-pixel search using the best match pixel.

13. The system in accordance to claim 10, wherein the match error calculation module computes match errors at substantially all pixels within a portion of the search area encompassing the selected pixel of the first group.

14. The system in accordance to claim 10, wherein the match error calculation module computes a first match error by comparing a block of pixels in the current frame with a block of pixels in the reference frame that comprises one or more of the pixels of the first group.

15. The system in accordance to claim 14, wherein the match error calculation module computes a second match error by comparing a block of pixels in the current frame with a block of pixels in the reference frame that comprises one or more of the pixels of the second group.

16. The system in accordance to claim 10, wherein the selected pixel of the first group has a least match error among the first set of match errors.

17. The system in accordance to claim 10, wherein the search pattern generation module determines an angle degree separating each of the plurality of directional lines based on at least in part a size of the search area.

18. The system in accordance to claim 10, wherein a size of the second group of pixels varies according to a distance of the selected pixel of the first group in relation to the center of the search area.

19. A computer product for use in conjunction with a computer system for encoding video data comprising a current frame and a reference frame, the computer program product comprising a computer readable storage medium and a computer program mechanism embedded therein, the computer program mechanism comprising:
a. a search pattern generation program module for defining a plurality of directional lines on the search area, the directional lines originating from approximately a center of the search area;
b. a match error calculation program module for computing a first set of match errors at a first group of pixels lying on or near the plurality of directional lines and for computing a second set of match errors at a second group of pixels in the vicinity of a selected pixel of the first group; and
c. a motion vector generation program module for generating a motion vector based on at least in part the first and second sets of match errors.

20. The computer program product in accordance to claim 19, further comprising program module for selecting a best match pixel having a least match error among the first and second sets for sub-pixel search.

21. The computer program product in accordance to claim 20, further comprising program module for performing a sub-pixel search using the best match pixel.

22. The computer program product in accordance to claim 19, wherein the match error calculation program module comprises a program module for calculating match errors at substantially all pixels within a portion of the search area encompassing the selected pixel of the first group.

23. The computer program product in accordance to claim 19, wherein the match error calculation program module comprises a program module for calculating a first match error by comparing a block of pixels in the current frame with a block of pixels in the reference frame that comprises one or more of the pixels of the first group.

24. The computer program product in accordance to claim 23, wherein the match error calculation program module comprises a program module for calculating a second match error by comparing a block of pixels in the current frame with a block of pixels in the reference frame that comprises one or more of the pixels of the second group.

25. The computer program product in accordance to claim 19, wherein the selected pixel of the first group has a least match error among the first set of match errors.

26. The computer program product in accordance to claim 19, wherein search pattern generation program module comprises a program module for determining an angle degree separating each of the plurality of directional lines based on at least in part a size of the search area.

27. The computer program product in accordance to claim 19, wherein a size of the second group of pixels varies according to a distance of the selected pixel of the first group in relation to the center of the search area.
